(19) United States
(12) Patent Application Publication
(10) Pub. No.: US 2018/0025392 A1
(43) Pub. Date: Jan. 25, 2018

(54) METHODS AND SYSTEMS FOR ASSESSING AND MANAGING ASSET CONDITION

(71) Applicant: EDMOND HELSTAB, KANATA (CA)

(72) Inventor: EDMOND HELSTAB, KANATA (CA)

(21) Appl. No.: 15/654,057

(22) Filed: Jul. 19, 2017

(30) Foreign Application Priority Data
Jul. 22, 2016 (CA) 2936854

(51) Int. Cl. G06Q 30/02; G06Q 40/08; G06Q 10/10; G06Q 10/06

(52) U.S. Cl. CPC G06Q 30/0278; G06Q 10/06; G06Q 40/08; G06Q 10/10

(57) ABSTRACT

Reliable assessment data is important for individual and enterprises to make value judgements relating to the purchase, sale, use and disposal of assets. However, in the majority of instances one party is beholden to the other party for assessment information and this may be the truth, part of the truth or not the truth. Further, individual's assessments of a condition or severity of damage will vary even without considering their monetary benefits from adjusting these from their true values. it would therefore be beneficial to provide a system that provides users with an assessment report established through a standardized sequence of graphical user interfaces by another user so that a degree of standardization is introduced to the assessment reports the users access. Further, users can employ a summary assessment report/score within an advertisement for example that when selected triggers access to full assessment report.

### CROSS-REFERENCE TO RELATED APPLICATIONS

This application claims the benefit of priority from Canadian Patent Application 2,936,854 filed Jul. 22, 2016 entitled “Methods and Systems for Assessing and Managing Asset Condition.”

### FIELD OF THE INVENTION

This invention relates to asset condition determination and in particular to collection, presentation, and analysis of asset condition determination in conjunction with collective analysis data.

### BACKGROUND OF THE INVENTION

Motorised vehicles (or vehicle as used herein) represent one particular form of asset for which periodic or aperiodic assessments are required in order to establish a condition. This may be with respect to establishing a value for the vehicle for sale, trade-in, bartering, etc.; establishing a condition with respect to an insurance claim; establishing a condition prior to a user accepting “delivery” of the vehicle such as when purchased or being rented etc.; establishing a vehicle's condition at lease return, and establishing a condition upon return of the vehicle to its owner such as after being rented for example; and before/after an autonomous ride service, vehicle share use, or ride hailing use.

Whilst the Internet has enabled many aspects of business and commerce such as a user can now search for an asset to acquire or post an asset for sale that can be viewed by other users across areas and distances hitherto impossible the result is that also introduces hurdles to users. Whereas typically they would have been limited to classifieds in their printed form in their vicinity (e.g. Regina, Saskatchewan), today they can search online across all of Canada or North America. However, in general they will only have access to general information about a vehicle, such as year, make, model, mileage, trim level and price unless the vehicle is particularly rare and being offered through a specialist dealer.

Accordingly, users seek reliable and consistent information relating to the vehicle including not only that presented by the seller capturing their interest but also the condition of the vehicle prior to purchasing it remotely or travelling to inspect with the intention of purchasing the vehicle. This is especially important for so-called “high ticket” items such as used cars, trucks, motorcycles, boats, snowmobiles, and all-terrain vehicles as well as other assets such as sailing boats, power boats, gliders, aircraft, etc.

In addition to the sale and purchase of vehicles the growth of services such as vehicle sharing, car club services, and advent of autonomous vehicle ride services etc. would all benefit from a quick, effective and trusted condition assessment process. Inspection levels and frequencies should be configurable to reflect the appropriate levels of consumer protection and personal safety etc. and the duration of the user's use of the vehicle. For example, a short assessment may be appropriate for every pick-up/drop-off of a car share or autonomous ride/transport with periodic detailed assessments. However, a user seeking to purchase would generally require the detailed assessment as they are making in many instances a sizeable investment monetarily.

Historically, vehicle inspections have been performed manually using preprinted forms when in a distributed environment such as retail vehicle sales or insurance claims etc. An inspector would work from a form or check list on a clipboard as they visually inspect the vehicle. Defects would be noted on the form. Sometimes, such forms would include schematic illustrations (e.g., line drawings) of the item being inspected so the inspector could note location and type of damage. Historically, these reports were internal to the car dealership, insurance company, rental company, inspection agency (for lease returns, fleet management, etc.), ride hailing company etc. and not accessible by anyone else.

Accordingly, it would be beneficial to provide the general pool of vehicle owners, buyers, users, etc. with an assessment system that they can use themselves, e.g. when picking up a car share or selling a car, and which is accessible online as a record of inspections/assessments etc. Beneficially such an assessment system also means that where exploited in a widespread manner the inspections of a dealer when initially selling or reselling a vehicle can not only be accessed but compared directly to those made subsequently by a private seller subsequently etc. Further, a common assessment system would provide consistency of assessment by removing different standards and presenting each assessor with a common consistent series of guidelines on how to classify, measure, photograph, document etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to asset condition determination and in particular to collection, presentation, and analysis of asset condition determination in conjunction with collective analysis data.

In accordance with an embodiment of the invention there are provided computer executable instructions stored on a non-volatile non-transitory storage medium for execution by a microprocessor, the instructions when executed by the microprocessor relating to a process comprising the steps of:
receiving upon an electronic device comprising the microprocessor and non-volatile non-transitory storage medium a vehicle condition query from a remote electronic device comprising information relating to an assessment to be performed;
receiving identification data of a vehicle for transmittal to the remote electronic device allowing remote verification that the vehicle to which the identification data relates is the vehicle to which the vehicle condition query relates;
   upon verification providing to a user of the electronic device access to a vehicle condition query completion process comprising:
   retrieving from a first remote database data metrics corresponding to the vehicle associated with the vehicle condition query;
   retrieving from a second remote database schematic data corresponding to the vehicle associated with the vehicle condition query, the schematic data relating to at least one of interior schematics, exterior schematics, and engineering schematics of the vehicle;
   providing a graphical user interface allowing the user to identify specific areas of the vehicle;
   providing to the user within the graphical user interface a means to associate text data and image data to the identified specific area of the vehicle; and
transmitting for storage in association with at least one of the vehicle condition query and verified identification data to a third remote database inspection data relating to the identified specific areas of the vehicle together with their associated text data and image data.

In accordance with an embodiment of the invention there is provided a method comprising the steps of:
receiving upon an electronic device comprising the microprocessor and non-volatile non-transitory storage medium a vehicle condition query from a remote electronic device comprising information relating to an assessment to be performed;
receiving identification data of a vehicle for transmittal to the remote electronic device allowing remote verification that the vehicle to which the identification data relates is the vehicle to which the vehicle condition query relates;
   upon verification providing to a user of the electronic device access to a vehicle condition query completion process comprising:
   retrieving from a first remote database data metrics corresponding to the vehicle associated with the vehicle condition query;
   retrieving from a second remote database schematic data corresponding to the vehicle associated with the vehicle condition query, the schematic data relating to at least one of interior schematics, exterior schematics, and engineering schematics of the vehicle;
   providing a graphical user interface allowing the user to identify specific areas of the vehicle;
   providing to the user within the graphical user interface a means to associate text data and image data to the identified specific area of the vehicle;
   establishing communications between the electronic device and a vehicle management system associated with the vehicle and retrieving vehicle stored inspection data; and
transmitting for storage in association with at least one of the vehicle condition query and verified identification data to a third remote database inspection data relating to the identified specific areas of the vehicle together with their associated text data and image data.

In accordance with an embodiment of the invention there is provided a method comprising the steps of:
receiving at a server a request for assessment data relating to a vehicle, the request including at least vehicle identification data of the vehicle and an electronic address of a remote electronic device to which the assessment data is to be sent
   upon verification of the request transmitting to the remote electronic device an assessment report, the assessment report generated in dependence upon an aspect of the request and comprising:
   a first portion retrieved from a first database relating to data metrics corresponding to the vehicle associated with the vehicle identification data;
   a second portion retrieved from a second database relating to schematic data corresponding to the vehicle associated with the vehicle identification data, the schematic data relating to at least one of interior schematics, exterior schematics, and engineering schematics of the vehicle;
   a third portion retrieved from a third database relating to content previously generated by a user performing an assessment of the vehicle, the content comprising at least one of audiovisual images, visual images, text data, classification data, and classification ratings; and
   an assessment score determined by one or more algorithms employing a predetermined portion of the content previously generated by the user performing an assessment of the vehicle.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts an electronic device and network environment supporting vehicle assessment applications, systems and platforms according to embodiments of the invention;

FIG. 1B depicts schematically the concept of vehicle assessment applications, systems and platforms according to embodiments of the invention;

FIG. 2 depicts a touch screen based inspection interface supporting vehicle assessment applications, systems and platforms according to embodiments of the invention wherein the user begins an assessment process by selecting a category of vehicle;

FIGS. 3A through 3M depict exemplary user interfaces presented to a user exploiting vehicle assessment applications, systems and platforms according to embodiments of the invention;

FIGS. 4A and 4B depict examples of exterior and interior schematics presented to a user via a user interface within vehicle assessment applications, systems and platforms according to embodiments of the invention;

FIG. 5 depicts an exemplary schematic process flow for a user employing a vehicle assessment application, system and platform according to embodiments of the invention;

FIGS. 6A and 6B depict exemplary server and web server deployment scenarios for vehicle assessment applications, systems and platforms according to embodiments of the invention; and

FIG. 7 depicts an exemplary deployment scenario for vehicle assessment applications, systems and platforms according to embodiments of the invention wherein assessment data is stored directly into a mass storage device.

### DETAILED DESCRIPTION

The present invention is directed to asset condition determination and in particular to collection, presentation, and analysis of asset condition determination in conjunction with collective analysis data.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information and/or user profile information.

A “wearable device” or “wearable sensor” relates to miniature electronic devices that are worn by the user including those under, within, with or on top of clothing and are part of a broader general class of wearable technology which includes “wearable computers.” Such wearable devices and/or wearable sensors may include, but not be limited to, smartphones, smart watches, e-textiles, and smart glasses.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer of the adult device or established by an individual through a user interface to the adult device or a PED/FED in communication with the adult device.

A “vehicle identification number” (VIN), also referred to as a chassis number, as used herein, and throughout this disclosure, relates to a unique code including a serial number employed by the automotive industry to identify individual motor vehicles, towed vehicles, motorcycles, scooters and mopeds. A VIN may be configured according to an international standard, national standard, or industry standard including, but not limited to, FMVSS 115, ISO 3779, SAE J853, and ADR 61/2. A VIN may be configured to include a unique manufacturer identifier (which may include a country code), a Vehicle Descriptor Section (VDS) to identify the vehicle type, and may include information on the automobile platform used, the model, and the body style, and a Vehicle Identifier Section used by the manufacturer to identify the individual vehicle in question. This may include information on options installed or engine and transmission choices, but is often a simple sequential code, alphanumberic for example. Within this specification as the embodiments of the invention are described with respect to vehicular asset assessments etc. the term VIN has been employed. However, it would be evident to one skilled in the art that the VIN is simple the vehicle specific unique identifier of an asset within a class of assets and that other identification numbers and/or codes may be employed without departing from the scope of the invention.

“Data metrics” as used herein, and throughout this disclosure, relates to asset information such as manufacturer, manufacturer model, year of manufacture, colour etc. For other assets these and/or other information may for the data metrics which are employed in categorising the asset for storage within a database and/or as filter/search terms of user performing an asset search. For example, a search for “Honda, CR-V, 2010, *” implying 2010 Honda CR-V vehicles of any colour, trim, etc. whilst “Cisco, Router, 10G, Ethernet” implies any Cisco Router with 10 Gb/s Ethernet ports.

“Technical condition” data as used herein, and throughout this disclosure, relates to data and/or indications with respect to technical condition of an asset. For example, this may include usage data (e.g. mileage), warning indicators (e.g. warning lights or messages on display system of asset), etc.

“Schematic data” as used herein, and throughout this disclosure, relates to outlines, line drawings, engineering drawings, architectural drawings, circuit diagrams, and schematics of an asset or a portion of an asset. In some instances, e.g. vehicles, there may be interior and exterior depictions.

“Photographic data”, “defect data”, photographic defect data”, “video data”, “informational data” as used herein, and throughout this disclosure, relate to electronic data and/or electronic content acquired and stored in association with an asset within an asset assessment and management application, system and platform platforms according to an embodiment of the invention. Such electronic data and/or electronic content may be entered directly with respect to an asset or associated with an asset.

Reference to a “barcode” as used herein may refer to, but is not limited to, an optical machine-readable representation of data relating to an item to which it is attached and/or printed upon. A barcode employs a symbology mapping data to elements within the barcode as well as one or more other elements including, but not limited to, orientation markers, start-stop markers, quiet zones, and checksums. Such symbologies include, but are not limited to, linear symbologies, continuous symbologies, discrete symbologies, two-width symbologies, many-width symbologies, interleaved symbologies, matrix symbologies, and two-dimensional (2D) symbologies. Examples of linear and 2D or matrix symbologies may be found listed in Wikipedia, see http://en.wikipedia.org/wiki/Barcode#Symbologies, and therein the public domain references referred to. Some barcodes, e.g. QR codes, may further support multiple variants, comprising:
different models, e.g. QR code Model 1 and QR code Model 2;
different versions, e.g. QR code Version 1 at 21×21 and QR code Version 40 at 177×177; and
different error correction codes, e.g. L, M, Q, and H that support damage levels up to 7%, 15%, 25%, and 30%.

Reference to a “vehicle management system” (VMS) as used herein may refer to, but is not limited to, an off-board application or system for managing data relating to a vehicle or an on-board system for managing operations of the vehicle and storing data relating to its operation. An off-board vehicle management system may support processes relating to establishing and managing data relating to a vehicle from multiple organizations including, but not limited to, the original equipment manufacturer (OEM), new and used vehicle dealers etc. and integration of various processes such as procurement, sales, rework, returns processing, trade-in and service processing as well as the archiving of vehicle data. An on-board system today may provide access to use, condition and operating error data through what is called the On Board Diagnostics (OBD) interface via a plug in connection used to access vehicle use data (acceleration events, maximum speeds, etc.), service history and maintenance requirements, function error codes (engine, brakes, emissions, etc.), emissions functions/testing, programming of vehicle functions, vehicle function upgrades, software upgrades, etc. Communication with the embedded software and operating system of an OTB may be via wired or wireless interface allowing dealers to support servicing and manufacturers to provide support and upgrades. An OBD and/or VMS may support interaction with external systems and other vehicles to facilitate autonomous services in addition to application programming interfaces (APIs) for third parties.

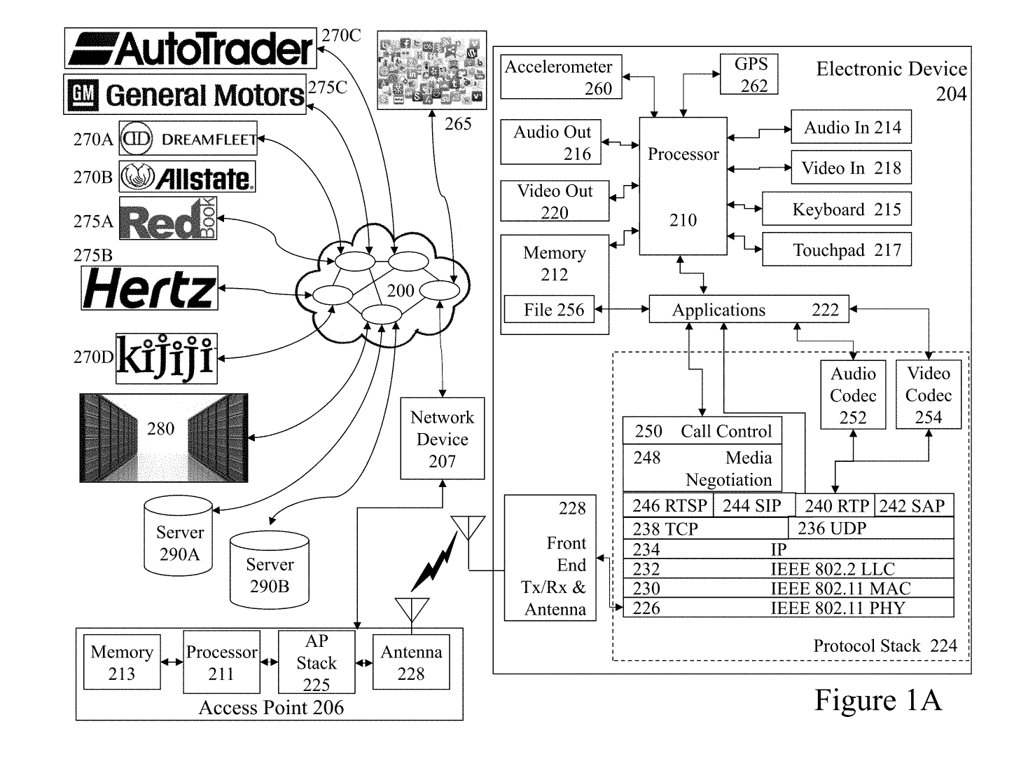

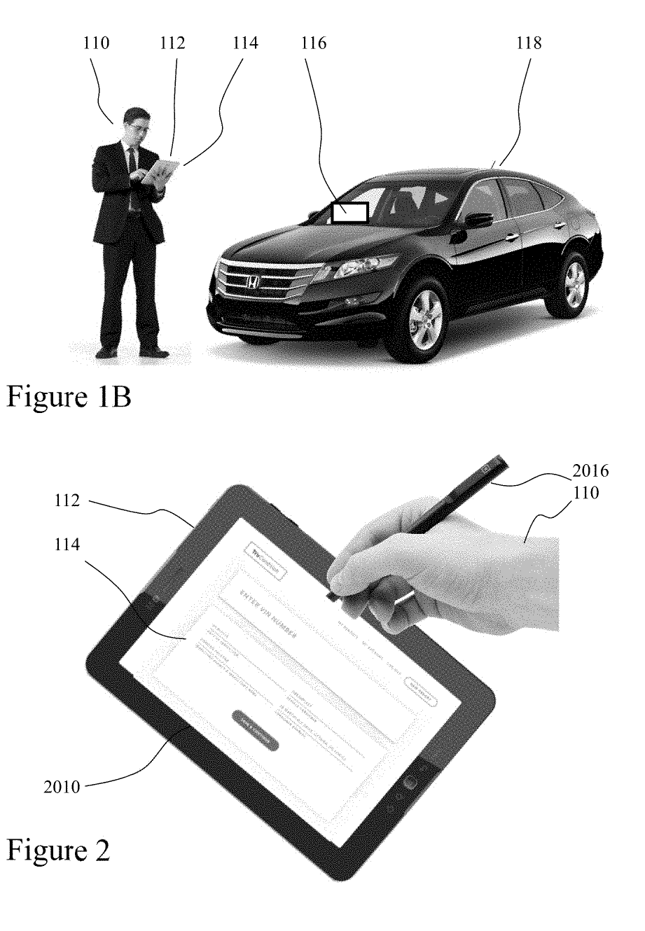

Referring to FIG. 1A there is depicted an Electronic Device 204 supporting communications to a network and therein remote servers, devices, etc. as supporting software applications according to embodiments of the invention such as Asset Assessment and Management Application, Software and/or Platform (AAM-ASP) according to an embodiment or embodiments of the invention. Accordingly, an Electronic Device 204 is connected to Network 200 which is then coupled to a Remote Central Exchange 280 which communicates with the remainder of a telecommunication service providers network via Network 200 and/or other networks which may include for example long-haul OC-48/OC-192 backbone elements, an OC-48 wide area network (WAN), a Passive Optical Network, and a Wireless Link. The Remote Central Exchange 280 is connected via Network 200 and/or other networks to local, regional, and international exchanges (not shown for clarity). Electronic Device 204 is connected to Network 200 via an Access Point 206 and Network Device 207. The wireless communications between Electronic Device 204 and Access Point 206 may be through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices such as Electronic Device 204 may communicate directly to Access Point 206 or it may form an association with another electronic device through standards such as IEEE 802.15 and Bluetooth as well in an ad-hoc manner to communicate with the Access Point 206.

Access Point 206 is depicted as connected to Network Device 207 and therein Network 200 via a wired interface which may be through one or more wired communications standards such as, including, but not limited to, DSL, Dial-Up, DOCSIS, Ethernet, G.hn, ISDN, MoCA, PON, and Power line communication (PLC) which may or may not be routed through a router (not shown for clarity). Alternatively, Electronic Device 204 may be connected to Access Point 206 via a wired connection and Access Point 206 connected to Network Device 207 via a wireless interface. Also connected to the Network 200 are:
Social Networks (SOCNETS) 265;
Software provider 270A, e.g. DreamFleet™;
Financial service provider 270B, e.g. AllState™ Insurance;
First and second online service providers 270C and 270D respectively, e.g. AutoTrader™ and Kijiji™;
Automobile industry resource 275A, e.g. RedBook™;
Automobile service provider 275B, e.g. Hertz™ car rental; and
Original equipment manufacturer (OEM) 275C, e.g. General Motors™.

Also connected to Network 200 are first and second servers 290A and 290B which together with others, not shown for clarity. First and second servers 290A and 290B may host according to embodiments of the inventions multiple services associated with a provider of Asset Assessment and Management software tools, a provider of Asset Assessment and Management Applications, Software, and/or Platforms (AAM-ASPs); a provider of a SOCNET or Social Media (SOME) exploiting AAM-ASP features; a provider of a SOCNET and/or SOME not exploiting AAM-ASP features; a provider of services to PEDS and/or FEDS; a provider of one or more aspects of wired and/or wireless communications; license databases; content databases; image databases; content libraries; customer databases; websites; and software applications for download to or access by FEDs and/or PEDs exploiting and/or hosting AAM-ASP features. First and second primary servers 290A and 290B may also host for example other Internet services such as a search engine, financial services, third party applications and other Internet based services.

Accordingly, a user may exploit Electronic Device 204 to access first and/or second primary servers 290A and 290B respectively to perform an operation such as accessing/downloading an application which provides AAM-ASP features according to embodiments of the invention; execute an application already installed providing AAM-ASP features; execute a web based application providing AAM-ASP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210.

Electronic Device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 21, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Electronic Device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, IMT-1000, DSL, Dial-Up, DOCSIS, Ethernet, G.hn, ISDN, MoCA, PON, and Power line communication (PLC).

Within FIGS. 1B to 6B respectively exemplary illustrative non-limiting implementations of the technology and/or concepts described within the following section of the specification are depicted relating to AAM-ASPs and more particularly to PED and/or FED based inspection data collection systems and methods adapted to meet the inspection, assessment and management aspects of users within a range of applications from personal asset sale and/or purchase, through fleet management, insurance, etc. to OEM analytics, etc. Embodiments of the invention are intended to address the provisioning of standardised asset assessment forms to users, both directly and indirectly associated, with an asset or group of assets (e.g. a user's personal collection or corporate fleet etc.). In order to support decentralized AAM-ASP data collection each inspector, user, exploits access to a PED and/or FED allowing them to connect to a remote server or web portal via a network to access the AAM-ASP and therein perform one or more tasks including, but not limited to, add/amend an assessment, extract a summary report, verify assessment data, search for an asset, extract analytics for a class or type of asset. In some instances, communications such as performing an assessment the inspector (user) is presented with standardized asset schematics allowing them to identify aspects of the asset together with associated text and/or image content which are then remotely stored, analysed, assessed etc. either through third party providers.

Referring to FIG. 1B there is depicted schematically the concept of an asset assessment and management application, system and platform (AAM-ASP) according to embodiments of the invention in respect of vehicle assessments. As depicted, a user 110, e.g. an inspector associated with a third party provider or OEM for example or the vehicle owner, is employing a PED 112, such as a tablet computer, with a touch screen upon which a graphical user interface (GUI) 114 in order to perform an assessment of a Vehicle 118. Whilst Vehicle 118 is depicted as a passenger car it may any type of vehicle including, for example a passenger car, a sport utility vehicle, a light truck, a heavy truck, construction equipment, a motorcycle, a boat or other watercraft, an airplane or other aircraft, or any other type of motor vehicle. Upon establishing a connection to the remote server or web portal of the AAM-ASP the user 110 is prompted to enter Vehicle Identification (VEH-ID) 116 data, such as through data entry, image capture with associated optical character recognition, image capture with barcode interpretation, or scanning a bar code. Accordingly, with motor vehicles this vehicle identification data 116 may comprise the Vehicle Identification Number (VIN). Whilst embodiments of the invention are described with the essential assumption that the user's PED/FED is connected to the Internet, a global data based network functioning as Network 200, it would be evident that in some embodiments of the invention the AAM-ASP is installed on the user's PED/FED and may therefore execute part or all of the assessment stages without a connection to the Network 200 based upon the information stored within the AAM-ASP on the user's PED/FED. For example, if the user is a private individual then the AAM-ASP may have stored schematics/data for the user's asset(s) on their PED-FED from a previous use which is accessible this time around. In other instances, where the user is an assessor/inspector for example, then they may have installed a library containing schematics/data for the major asset types/brands that they inspect. Accordingly, a vehicle inspector may have already installed interior and exterior schematics of all vehicles from the major OEMs retailing in the United States when they are based in the United States.

Based upon the vehicle identification information, the AAM-ASP performs a database look up of the identification data and auto populates the specifications portion of the document being prepared, e.g. a sale report, an insurance report, or an assessment report, based on this database lookup, which may be third party database. Alternatively, an administrator or the inspector (User 110) can input the VEH-ID 116 into the device centralized software for the assets scheduled for inspection into the PED 112 in advance of the actual inspections and download additional data, such as described below, prior to traveling to the vehicle location. Optionally, the AAM-ASP with or without network access is the same software application installed on the electronic device whilst in other applications discrete AAM-ASP applications may be provided for network access and no network access, or private versus commercial users for example.

Now referring to FIG. 2 there is depicted a touch screen based inspection interface supporting vehicle assessment applications, systems and platforms according to embodiments of the invention wherein the user begins an assessment process by selecting a category of vehicle. Accordingly, the AAM-ASP is executing and displaying a graphical user interface (GUI) to a user on the PED 112 although it would be evident that the PED 112 may be alternatively a FED and that rather than a touch screen a range of other haptic interfaces may be employed to make menu selections, enter data etc. within an AAM-ASP according to embodiments of the invention. In this instance the GUI is Data Metrics 2010 and the user enters touch screen 114 of the portable Device 112. The portable Device 112 receives data metrics 2010, such as make, model and year, which either provide for cross-reference to an established unique identification number, e.g. the VIN of a motor vehicle, or the basis of subsequent information alone or in combination with other data. The Data Metrics 2010 are entered by the User 110 via a Stylus 2016 as depicted although it would be evident that other haptic interfaces may be employed in addition to the user's own direct touch to a touch screen or alternatively through voice recognition of data entered by the User 110 through a microphone of the PED 112. In some instances, the User 110 may make amendments or corrections to data automatically retrieved.

Subsequently, the User 110 is then prompted to take a series of documentary images and/or video of the vehicle being inspected. Within an embodiment of the invention where a PED incorporates a camera then the AAM-ASP “walks” the User 110 through a guided process to take a series of sequential photographs of the interior and exterior of the vehicle in accordance with specific instructions and image composition guidelines. These image composition guidelines may be in the form of three dimensional translucent depictions of the required images depicted on the camera display screen on the PED such that the User 110 can align to this such that photographs captured over an extended number of assessments or time are approximately consistent in scale and portion of the vehicle or such that the images from multiple Users 110 are similarly approximately consistent when presented to another User 110 browsing for a vehicle. Alternatively, the user is guided by an exterior schematic or the interior schematic etc. The AAM-ASP guides the User 110 through the image capture process as the interior and exterior photographs are tagged/labelled and saved to the report. Once the User 110 is satisfied with the photos they select a completion button or move to the next stage through a menu bar or drop-down menu etc.

The User 110 is prompted to input technical condition data, such as mileage, exterior condition, interior condition, mechanical condition and road test results through a series of menus that are sequentially displayed and provided to the user or accessed through a menu bar/drop-down menus etc. through techniques known in the prior art for GUIs. Mechanical and/or electrical condition data may be gathered directly through physical inspection means or indirectly via a vehicle management system with its archived OBD data etc. obtained from the vehicles' embedded management/operating system during servicing or during an inspection upon provisioning of appropriate credentials or separately stored OBD data for transmission to the VMS providing no direct interface to the vehicle's embedded management/operating system.

Some segments, such as mechanical condition, road test etc. may be optional whereas others are obligatory. Which segments are obligatory versus optional may vary according to the type of report being prepared which is selected at the beginning of the assessment or is determined by the AAM-ASP such as private, commercial-retail, commercial-insurance, etc. The AAM-ASP software walks the User 110 through element by element to rate the condition of each. The User 110 rates each on a slider scale with text descriptions of condition, moving along with their finger until the most accurate representation appears. Once all elements have been completed, a summary is presented to the User 110 allowing them to confirm or modify their observations. Some embodiments of the invention where the haptic interface is a touch screen may allow the user to use their fingers for selections etc. or they may require the User 110 to employ a stylus in some aspects such as defining regions of interior/exterior to which the User 110 is making a comment or adding an image against. A stylus may, in such instances, provide enhanced precision although the user may alternatively magnify/minify the schematic upon the GUI 114 to aid their depiction/selection etc. with their finger and/or in combination with another haptic interface.

Within an embodiment of the invention when the user is presented with an exterior schematic this is displayed on the GUI 114 of the PED 112. The PED 112 receives exterior schematic such as an outline or line drawing of the exterior of the vehicle to be inspected. The exterior schematic corresponds to the type of vehicle, such as 2-door, 4-door, hatch, compact, sedan, sports utility vehicle, truck or other vehicle type, corresponding to the VEH-ID 116 inputted by the User 110. Optionally, the user may be presented with a photograph of the vehicle and asked to confirm correct vehicle prior to being presented the exterior schematic. Optionally, the data entry etc. may be performed using a photographic image, 3D rendered CAD image etc. Optionally, in the example of 3D CAD the user may rotate and zoom the image to make it easier to add information to specific sections of the vehicle's exterior.

Within an embodiment of the invention when the user is presented with an interior schematic this is displayed on the GUI 114 of the PED 112. The PED 112 receives interior schematic such as an outline or line drawing of the interior of the vehicle to be inspected. The interior schematic corresponds to the type of vehicle, such as 2-door, 4-door, hatch, compact. sedan, sports utility vehicle, truck or other vehicle type, corresponding to the VEH-ID 116 inputted by the User 110. Optionally, the user may be presented with a photograph of the vehicle interior according to the database configuration of the vehicle and asked to confirm correct vehicle prior to being presented the exterior schematic in line drawing form. Optionally, the data entry etc. may be performed using a photographic image, 3D rendered CAD image etc. Optionally, in the example of 3D CAD the user may rotate and zoom the image to make it easier to add information to specific sections of the vehicle's interior.

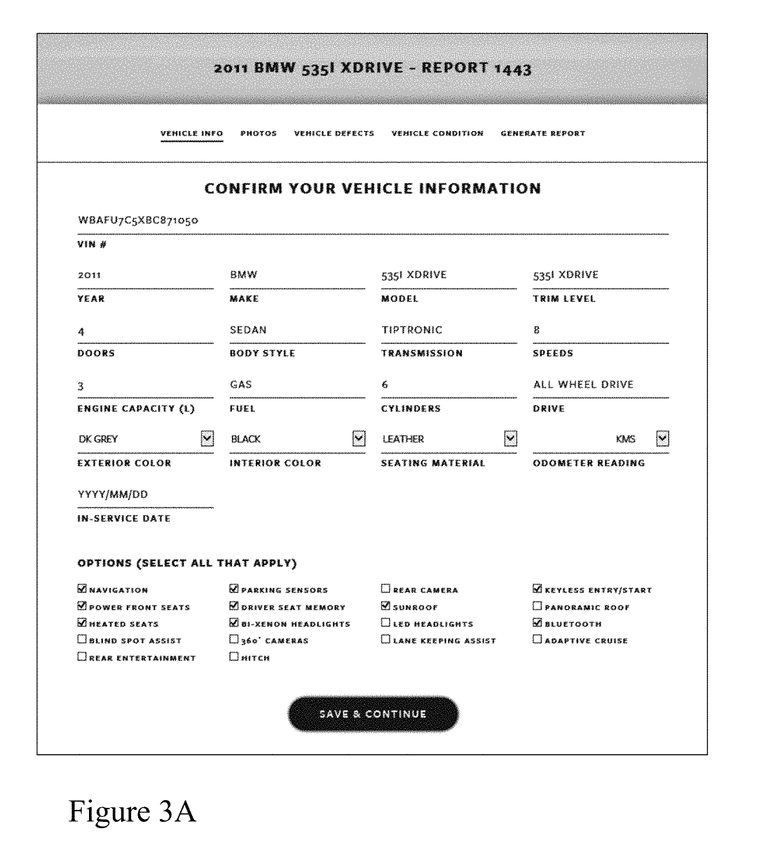

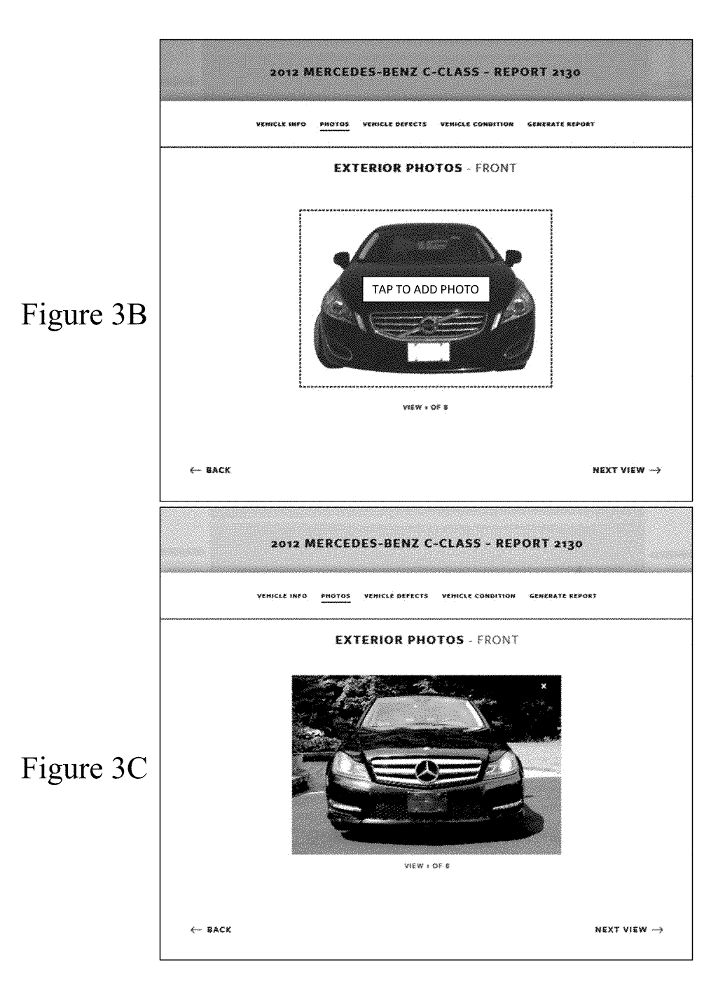

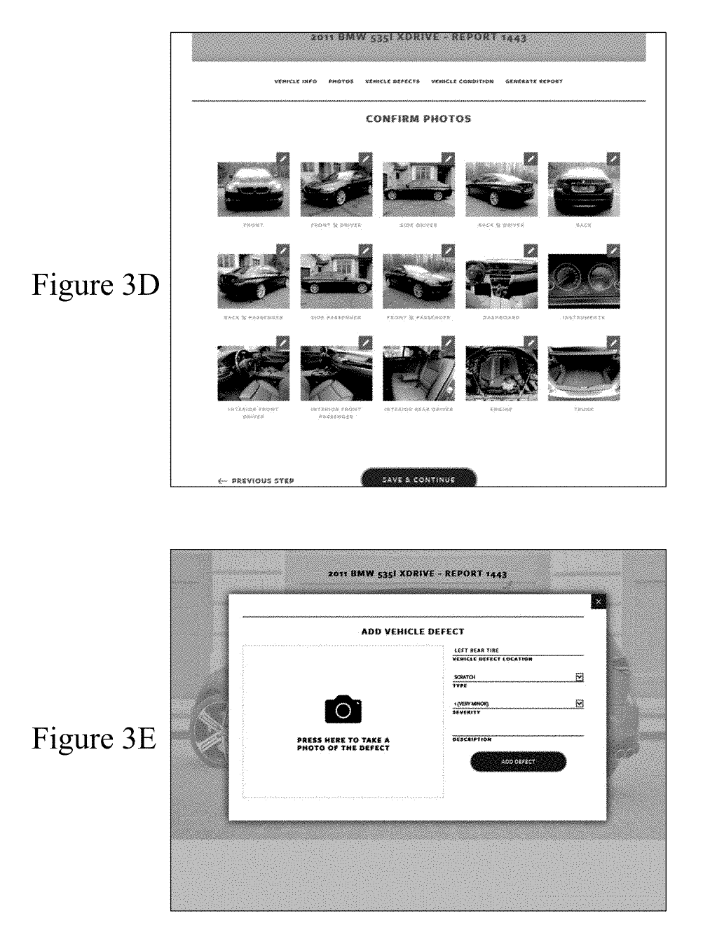

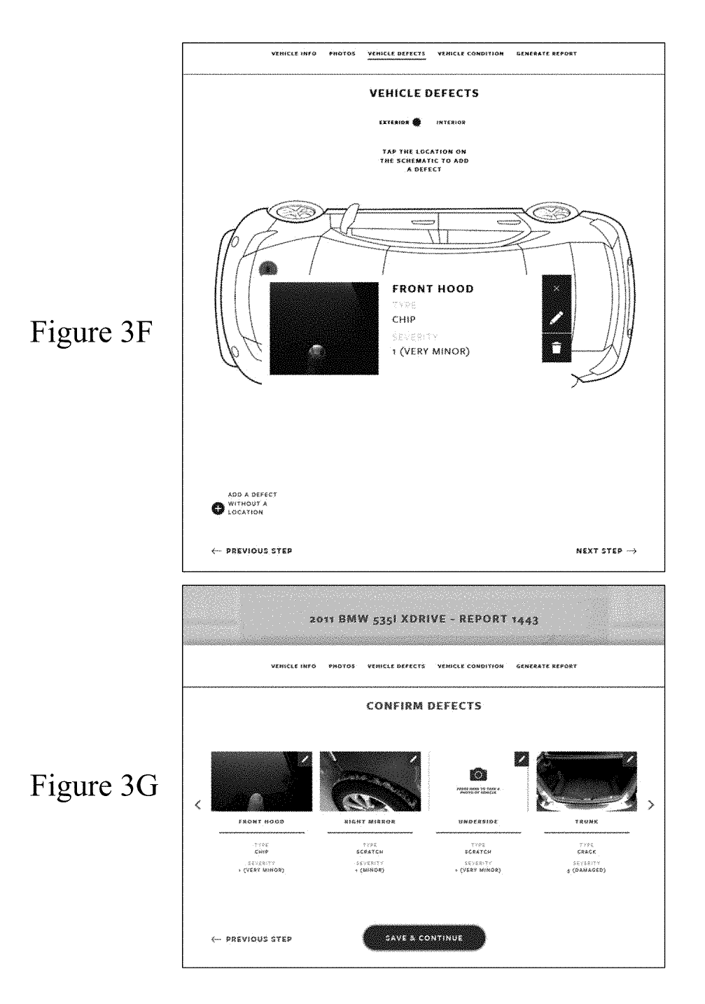

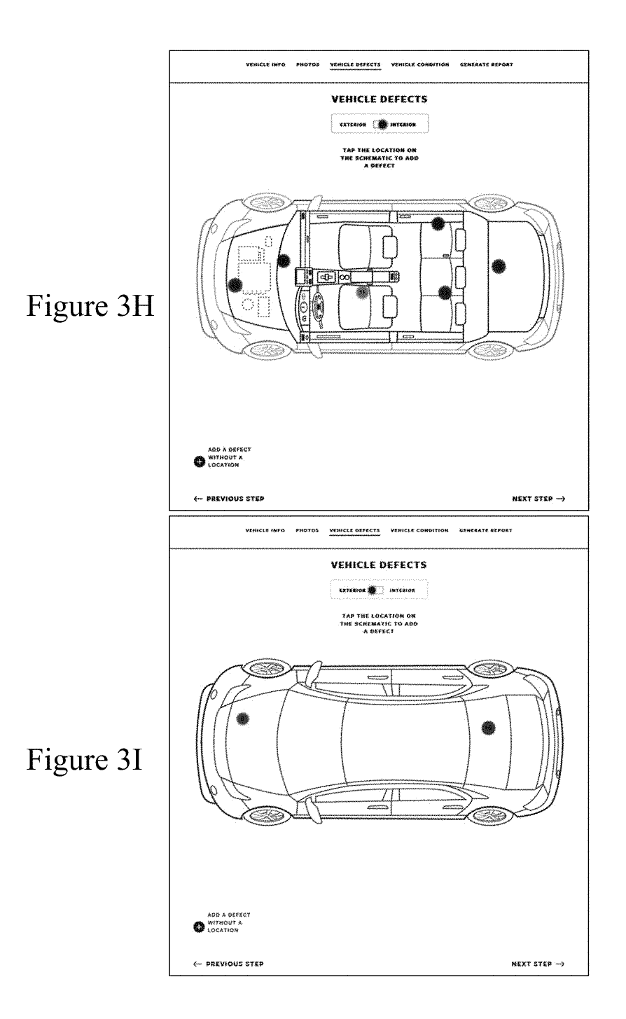

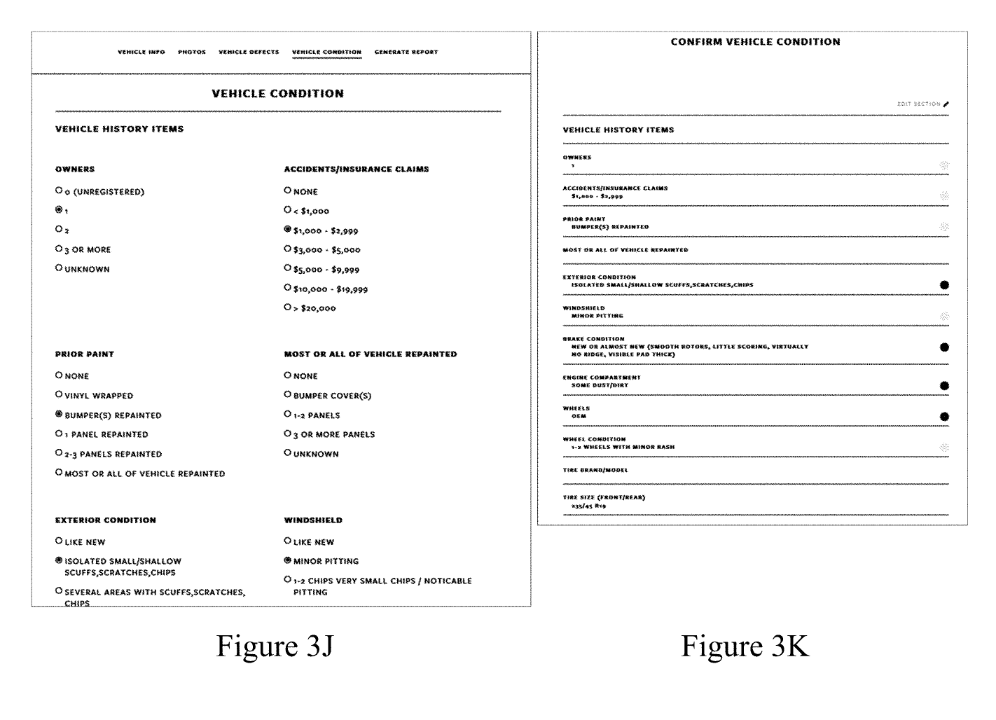

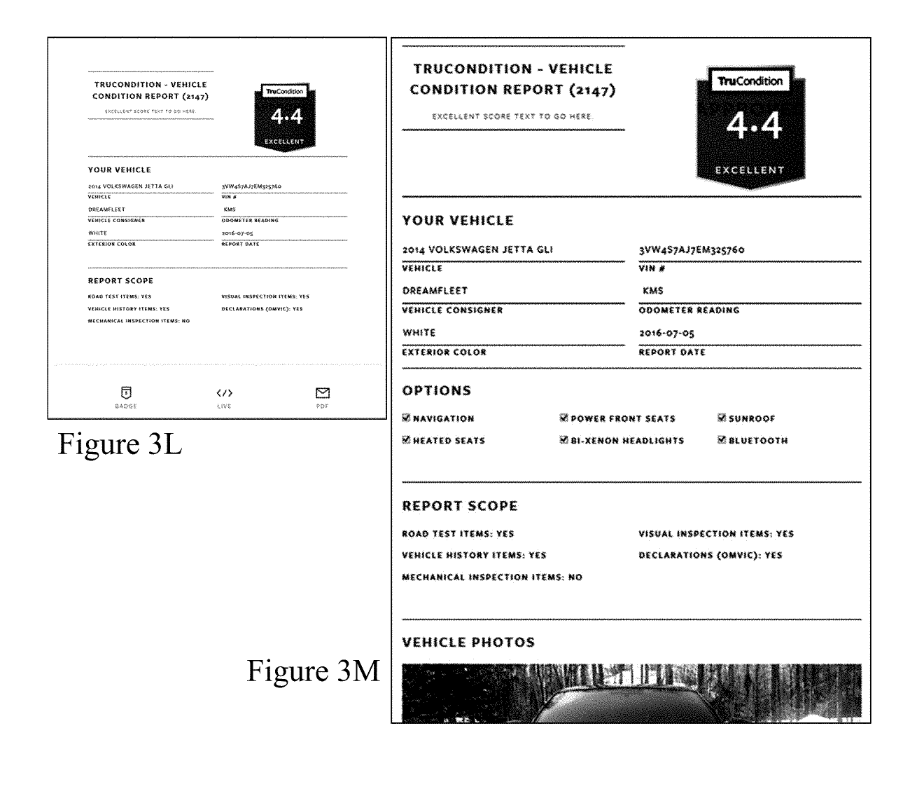

Referring to FIGS. 3A through 3M there are depicted exemplary user interfaces presented to a user exploiting an AAM-ASP according to embodiments of the invention. These represent steps within an overall sequence comprising:
VEHICLE INFORMATION—Enter the VIN and get the vehicle information;
IMAGE CAPTURE—Take photographs/videos and confirm;
DEFECTS—Enter the defects with photographs/videos and confirm;
VEHICLE CONDITION—Inspect the vehicle and answer the condition questions sequentially with confirmation actions with, for example, Green, Yellow, Orange, Red coding signifying good to poor on each applicable question. Overall, the vehicle condition is comprised of a visual, road test, and mechanical inspection components. The road test and mechanical inspection components are optional in many instances such as insurance valuations but required in others, e.g. dealer purchase.
GENERATE REPORT & CONDITION SCORE—Submit inspection data to remote central server wherein a summary report and grading are generated and transmitted back to inspector. A “badge” is available for website/portal posting that links to the Report. In this manner a seller can book an inspection, obtain the report, post the report as part of a sale on an online website, and any potential buyer clicking on the “badge” is linked to the detailed report on that vehicle. It would be evident that additional security and encoding/encryption etc. may be applied to prevent “spoofing” of weblinks to websites/webpages other than the actual inspection provider.

Considering initially FIG. 3A then exemplary initial assessment configuration GUI is depicted. However, prior to this the user may enter data such as relating to the inspector and their company, “TRUINSPECT, John Smith” together with owner and/address information of the vehicle owner.
FIG. 3A depicts a configuration GUI allowing the user to confirm and/or augment the information established in dependence upon the VIN, which defines make/year/model, such that, for example body style, colour, trim level and trim colour are defined for the vehicle;

Subsequently, the User 110 is guided through an external visual condition acquisition process of which exemplary GUIs are depicted in FIGS. 3C to 3E respectively and depicting:
FIG. 3B depicts an initial image acquisition GUI presenting the user with an outline view of the asset to align to, in this case the front of a car, such that there is consistency between captured images both for a single vehicle with multiple inspections and for multiple vehicles;
FIG. 3C depicts the image acquisition GUI after acquisition of the image of the front of the car; and
FIG. 3D depicts an exemplary GUI for images relating to an asset wherein the user is presented with the multiple image types together with each image or images they acquired allowing the user to select the best image for each image type rather than being limited to a single image. As depicted the User 110 has been asked to acquire images of the vehicle in different orientations/views both interior and exterior although it would be evident that the views to be acquired may be listed based upon the asset type. Optionally, an intermediate GUI may allow the user to select a preferred image from multiple images against a specific viewpoint if the system notes the user acquired multiple images of one or more specific views.

The User 110 is then asked to provide an overall assessment of vehicle exterior condition and identity through interior and exterior schematics the locations of defects of which exemplary GUIs are depicted in FIGS. 3E to 3H respectively and depicting:

Within the process the user when identifying defects may be prompted with one or more GUIs to aid their defect entry and standardize entries, such as via GUIs depicted in FIG. 3E for entry and FIGS. 3F and 3G respectively wherein the user may capture a defect in FIG. 3E, identify a location of the defect in FIG. 3F, and then confirm in FIG. 3G or vice-versa.

FIG. 3H depicts an asset condition GUI allowing the user to provide/review details of defects with respect to the interior of a vehicle by identifying a location and adding an image, note. video, etc.;

FIG. 3I depicts an asset condition GUI allowing the user to provide/review details of defects with respect to the exterior of a vehicle by identifying a location and adding an image, note. video, etc.;

FIG. 3J depicts an asset condition GUI summary presented to a user having progressed through the sequence of steps for an asset assessment allowing them to review and if necessary return to a previous step and adjust/amend/correct wherein in this portion of the GUI sequence they are presented with historical data.

FIG. 3K depicts a defect overview GUI for an asset wherein the vehicle condition data extracted from the historical data is presented with the user being able to modify items as appropriate to reflect either their inspection or additional asset owner data and confirm the condition for each defined item.

Upon completion of the assessment/inspection then a summary report may be generated according to a predetermined format such as depicted in FIGS. 3L and 3M respectively wherein the asset is identified “2014 Volkswagen Jetta GLI”, “White Exterior”, VIN 3VM4S7AJ7EM325760” together with an assessment rating “4.4.” The user has options in respect of the final assessment report including, but not limited to:
Badge, wherein an assessment quality badge can be generated and employed identifying the assessment programme and/or standard together with the assessment rating such that the rating can be used within an online sales advertisement for example. This may include a pseudo-randomly generated code such that another user viewing the advert may access the assessment database enter the code and verify the asset details and assessment score. In some embodiments of the invention the user by registering for an enhanced subscription may be able to access a fuller assessment history, detailed report, etc.
Live, wherein a summary assessment is formatted into a markup language compatible format allowing the summary assessment to be uploaded to an online marketplace, online database, SOCNET, SOME etc.
PDF, wherein a summary assessment is formatted into a portable document format allowing it to be attached to electronic messages, upload etc.
DOC, wherein a summary assessment is formatted into a standard document format such as a word processing application, database application, spreadsheet application, etc.
EMAIL, wherein a summary assessment is formatted into an email for transmission to another user or users.

Within an embodiment of the invention the assessment report is generated upon receipt of a request for an assessment report at a server, wherein the assessment report is generated in dependence upon factors such as identity of the requester, identity of the corporate entity to which the requester is associated, a subscription level, login credentials etc.

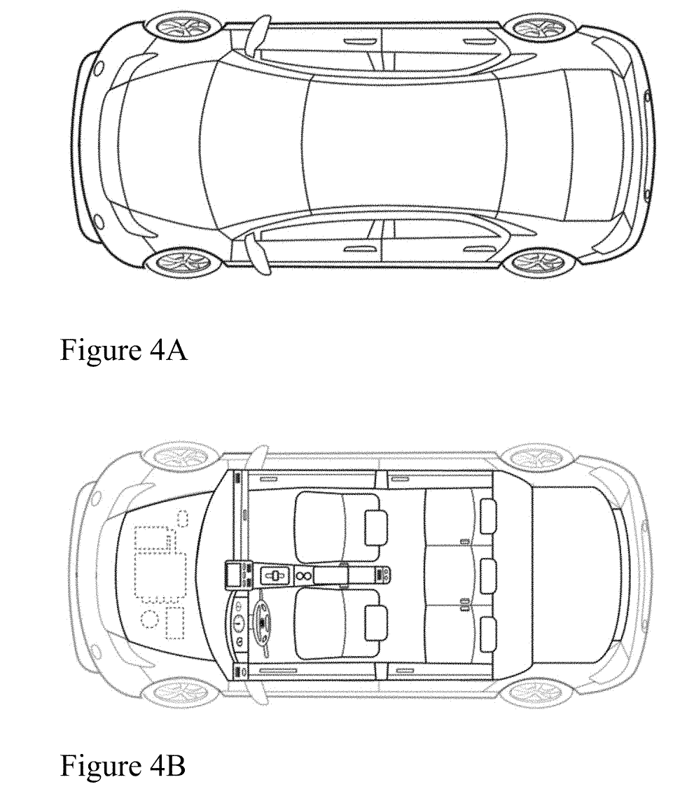

Referring to FIGS. 4A and 4B depict examples of Exterior Schematic 2012 and Interior Schematic 2014 respectively as used within an AAM-ASP according to an embodiment of the invention for defining locations of defects, identifying damage, or in part for aligning a photograph for standardization in acquired images.

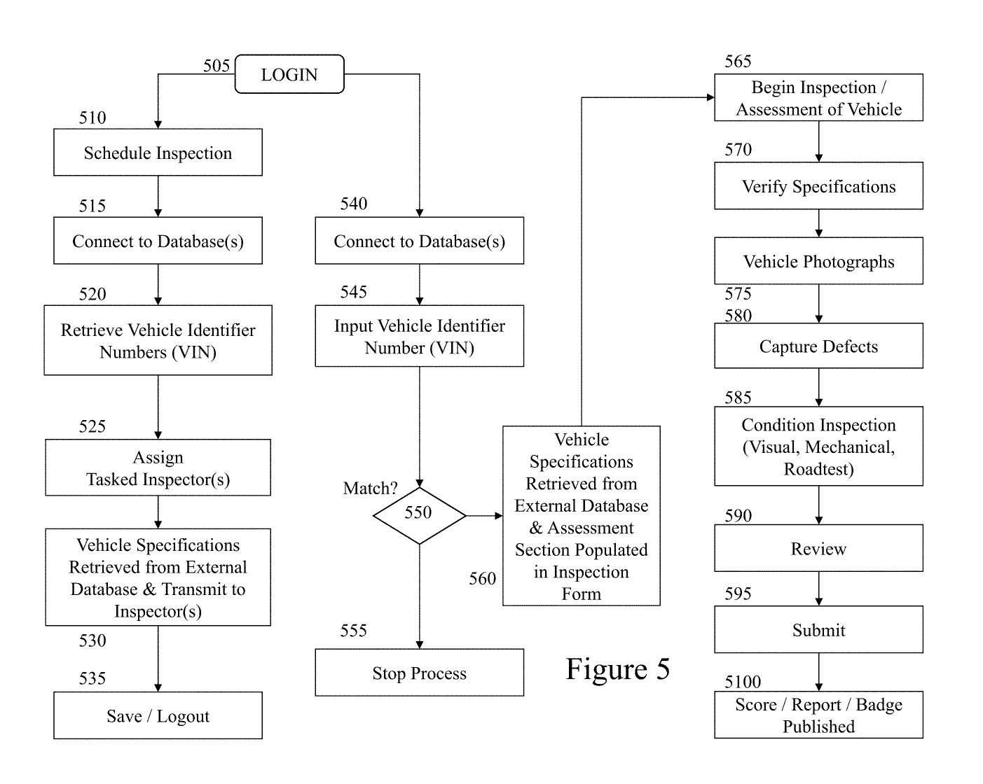

Referring to FIG. 5 there is depicted an exemplary process flow supported by an AAM-ASP according to an embodiment of the invention. Accordingly, in step 505 a User 110 accesses the AAM-ASP and completes a login process. If the login process relates to a supervisor or an inspector at a predetermined location the process executes a scheduling process depicted in steps 510 to 535 respectively. The predetermined location may be established through a geofence, an identity of an associated wireless base station, etc. according to processes as known in the art. If the login process relates to an inspector outside a predetermined location the process executes an assessment process depicted in steps 540 to 595B respectively.

Considering the scheduling process then the process proceeds to step 510 wherein criteria for establishing an asset or assets to be assessed is entered. For example, where the inspections relate to a fleet provider then this may be “Wednesday May 25, 2016”, “Boston, Mass.”, “ALL”, “Annual” such that all vehicles within region of Boston, Mass., USA are identified coming due for an annual assessment before or on Wednesday May 26, 2016 that have not been previously scheduled and/or completed since the last annual assessment. Alternatively, where the inspections relate to an insurance provider then this may be “Wednesday May 25, 2016”, “Boston, Mass.”, “ALL”, “Pending” wherein all pending inspections arising from insurance claims are identified. Subsequently, in step 515, the AAM-ASP connects to required database(s) and then in retrieves in step 520 the VINs associated with the search criteria and then in step 525 the inspector(s) are assigned to these retrieved VINs. Optionally, this assigned in automatic such as associating inspectors with predetermined territories/areas and allocating assessments on this basis or assessments are shared according to other criteria such as load balancing, type of asset, etc.

The process then proceeds to step 530 wherein the vehicle specifications are retrieved from internal/external databases as appropriate and transmitted to the inspectors for them to complete. For example, an inspection agency may perform assessments for several insurance providers and accordingly the data for each vehicle may be stored upon the different databases and/or servers of the different insurance companies. Upon completion of this step the process ends at step 535.

If, in step 505 a User 110 accesses the AAM-ASP, completes a login process, and the determination is that the login relates to an inspector outside a predetermined location the process executes an assessment process depicted in steps 540 to 595B respectively. Accordingly, in step 540 the inspector (User 110) connects to the database(s) at the location they are to perform an assessment at and enters the VIN of the physical vehicle at that location they are to assess. If in step 550 a mismatch is detected between the VIN associated with the assessment from the scheduling and the physical vehicle, then the process stops in step 555. It would be evident, however, that conflict resolution etc. may be performed to ensure that a simple error has not been made in respect of the VIN such as poor Optical Character Recognition (OCR) where the VIN is photographed in-situ and then established. However, such processes are known in the art and are not repeated here for brevity.

Upon determining that the vehicle VIN matches the scheduled assessment VIN then the process proceeds to step 560 wherein the vehicle specifications are retrieved from external database and/or User's 110 PED 204 (or FED) and the appropriate assessment sections populated within the AAM-ASP forms/GUIs as the User 110 progresses. Accordingly, the user either through a guided assessment without options or through a self-direction assessment using drop-down menus, tool bar options, etc. proceeds to perform the following steps:
Step 565 being beginning the inspection/assessment of vehicle;
Step 570 relating to verification of the specifications associated with the VIN and correction/amendment/addition.
Step 575 relating to capturing images of the assets, such as interior and exterior photographs through a guided sequence or according to defined list etc.
Step 580 relating to the capturing of any defects.
Step 585 relating to performing an assessment, e.g. condition inspection, in resect of visual, mechanical, etc. and where appropriate road test data which may be based upon an inspector's own road test or the entry of data from a provincial, state, Federal, national test mandated on the asset. For example, the results of the emission test, Government mandated inspection, etc. may be entered.
Step 590 relating to the inspector reviewing the data they have entered, images acquired etc.
Step 595 relating to the inspector submitting their assessment to a remote server(s).
Step 5100 relating to the generation of any associated score, report, badge, etc.

wherein this may be transmitted from the remote server(s) to the User 110 for forwarding or it may be automatically transmitted to contacts established within the remote server(s) associated with the vehicle which may be determined in dependence upon the type of assessment being performed.

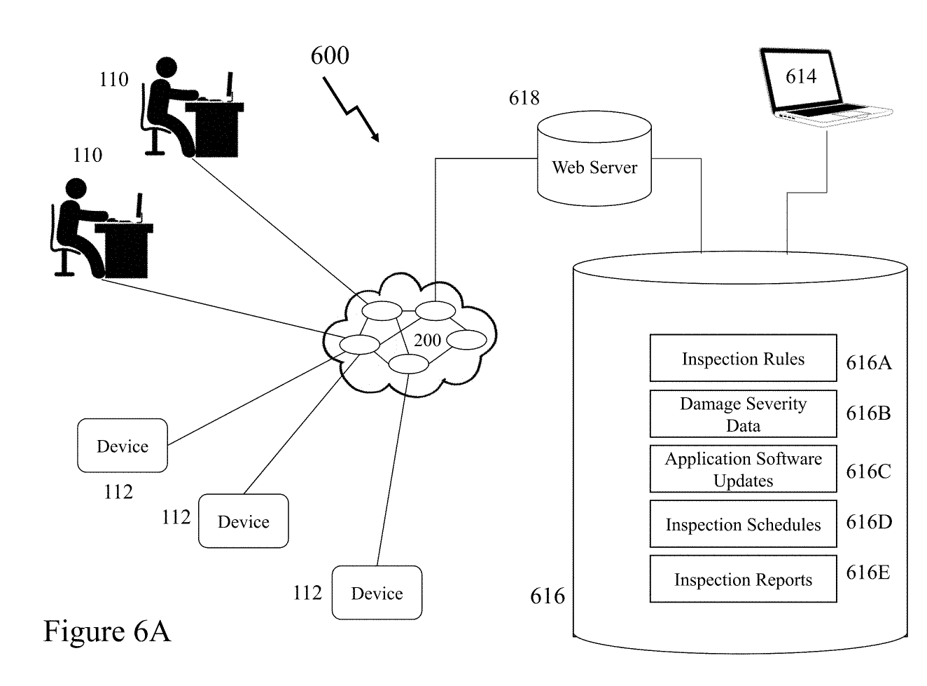

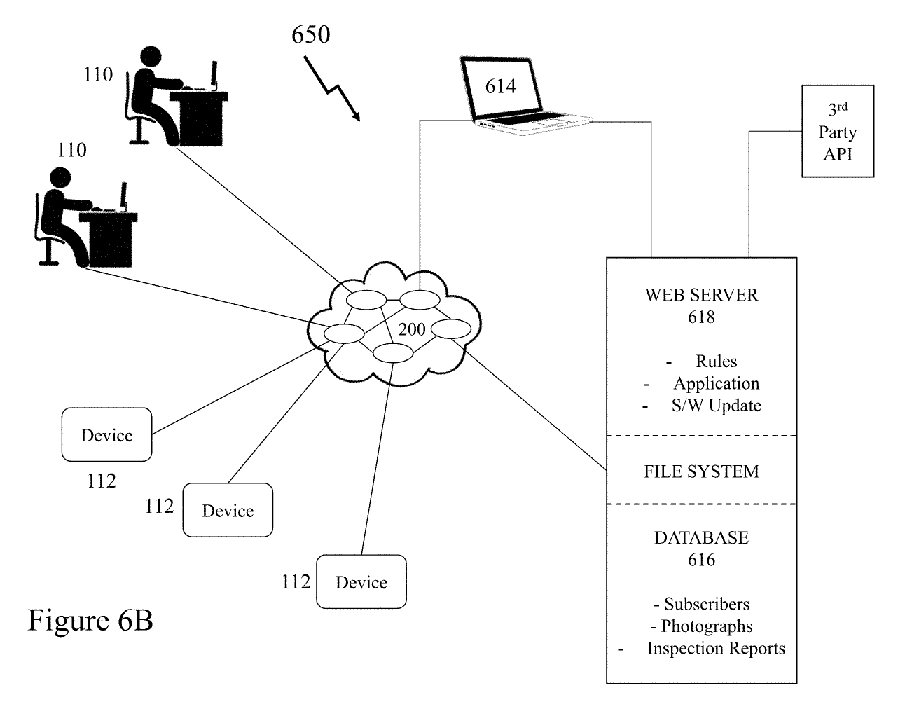

The steps 565 to 5100 depicted in FIG. 5 may exploit exemplary GUIs such as depicted supra in respect of FIGS. 3A to 3M respectively. The exemplary flow diagram presented in respect of FIG. 5 may be implemented within the exemplary system depicted in FIG. 1A and described supra or those in FIGS. 6A and 6B respectively described below. In each instance the software application associated with the AAM-ASP guides the User 110 to take a series of sequential photographs of the inside and outside of the vehicle in accordance with specific instructions, or is guided by the external schematic data 2012 and the internal schematic data 2014 displayed on the GUI 114 in FIGS. 2B and 2C respectively. These interior and exterior images together with others established by the User 110 in respect of defects are tagged and saved by means of the AAM-ASP to the database(s) in association with the data relating to the asset(s).

Considering process steps 560 to 5100 in FIG. 5 then AAM-ASP receives a download upon a valid VIN which may include, but not be limited to, software updates, rules updates, updated inspection schedule, interior-exterior schematics, vehicle data such as emission test, last recorded mileage, etc. Within embodiments of the invention the User 110 is presented with a hosted application such that they are entering data real time into the hosted application and database and the version of the application that they have access to may be determined by their login. Optionally, the AAM-ASP may allow the User 110 to add images/audio/video taken previously to the live form once Network 200 connected. Optionally, the User 110 may access a hybrid application which is launched on the device, e.g. Electronic Device 204, and provide for a more seamless integration between the device GUIs and its capabilities as well will allow for offline functionality, and then upload the data once connected to a Network 200. However, it is expected that most devices used for this purpose will be connected to the local network via Wi-Fi or the wide area network via cellular service.

Basic work-flow management capability will be typically implemented such as described supra in respect of pre-assignment of inspections although other embodiments of the invention may exploit a plug-in to provide workforce/job management functionalities such as a schedule of inspections, site locations and manual and GPS based geofence progress tracking etc. Accordingly, referring back to FIG. 5, when the User 110 logs onto their account at the inspection site, their scheduled inspection appear in their profile. Opening a scheduled inspection, the User 110 views the prepopulated inspection form with the inspection schedule is then downloaded and displayed along with data metrics 210, Exterior Schematic 2012, and Interior Schematic 2014. As noted supra the vehicle data can be entered when the User 110 logs in at the inspection location or it may be preloaded in advance of the actual inspection; i.e. a “Scheduled” inspection created by an administrator entering the vehicle VIN and the responsible User 110. Depending of the specific workflow practice, the “scheduled” reports may be generically assigned to a group or to a specific individual. Typically, only vehicle data will be prepopulated in a “scheduled” report. When the User 110 logs into the application the list of queued inspections (scheduled inspections) will be visible to them. They can then open the scheduled inspections and complete and submit them one by one. The data metrics driven from the VIN, exterior and interior schematic data driven from the vehicle type, will be prepopulated in the form.

In an alternative exemplary illustrative implementation, the User 110 may disconnect the Device 112 from the network and take the Device 112 to the location of the Vehicle 118 to be inspected. The User 110 then inputs VEH-ID 116 into the Device 112 and completes the inspection process whilst taking all the requisite photographs offline. Once they are able to connect to the Network 200, the locally stored data in the device is synchronized with the remote server(s) to complete the inspection process and generate the inspection form.

When connected to the Network 200 and receives an inspection schedule, data metrics 2010, Exterior Schematic 2012, and Interior Schematic 2014. In some embodiments of the invention the User 110 would need to connect to the Network 200 in order to complete the inspection whereas in other embodiments of the invention it is possible to complete the report offline and upload later. However, it is expected that there will be Network 200 access in the majority of cases and that real-time input of data (secured on a server) is the desired scenario of operation for the AAM-ASP. In this manner the data downloaded to the Device 112 may be partitioned and based upon User 110 progress through the assessment such that full device data is never stored within the Device 112.

The User 110 then begins the inspection process following the instructions displayed on the Device 112. The information contained in the VEH-ID 116 dictates the vehicle inspection procedure. The User 110 initiates the Device 112 to start the inspection process which is typically provided as a series of GUIs so that the User 110 is automatically taken through the various steps. In some embodiments of the invention the User 110 may be a private individual seeking to use the AAM-ASP to sell a vehicle and hence may be unfamiliar with it and hence require the step-by-step GUI sequence. However, where the User 110 us an inspector and familiar with the process they may exploit an alternate embodiment wherein they can enter data in their preferred or easiest sequence through the user of a toolbar and/or drop-down menus etc.

Considering, the step of a User 110 performing an exterior inspection of the Vehicle 118 then this may include, for example, standing at the left front fender and looking down at the exterior of the car at shallow angle to see dents, scratches and other defects. The User 110 may also, for example, walk the entire car, looking for dents and other imperfections from every angle (including the roof). This procedure allows the User 110 to have a general overall view of car to detect any collision or other damage. The User 110 may also, optionally, conduct a detailed inspection of the undercarriage, axle-drive-train, wheels, brakes, suspension, exhaust components, etc. Each time the User 110 finds damage, they can enter it into the PED 112 through the AAM-ASP GUI 114. As the User 110 walks around the Vehicle 118, (s)he uses a pointing implement, such as a finger 216 or stylus 218 to tap the GUI 114 of the PED 112 to interact with the internal executing software and input information. The User 110 also notes options and trim packages on the Vehicle 118, checks for accuracy of information automatically populated from the VEH-ID 116. The User 110 inputs Data Metrics 210 as narrative information either manually or from selection text from a dropdown menu, for example.

The User 110 then follows a similar procedure to inspect the interior of the vehicle 110 using the Device 112 to note all interior options, including color, cleanliness, odours, etc., and damage. The User 110 may again be guided through the process for the interior of the vehicle just as they were for the exterior of the vehicle and given specific positions and angles. Such photographs may include, for example, odometer, VIN plate, dashboard, seats, trunk, front view, rear view, driver side view, and passenger side view. It would be evident that the digital camera may be part of the PED 112 or it may be a separate device. If the photographs are taken on a separate device, the photographs may be uploaded to the PED 112 by wired or wireless means and the user may then be provided with a GUI to assign/allocate uploaded images to the correct target images and add any additional information/comments etc. Optionally, the embedded software in the Device 112 may seek to automatically assign the uploaded photographs to correct image locations in the condition report that the device is preparing based upon image processing/content recognition.

After entering and verifying the vehicles data metrics, the next step within some embodiments is to capture general photos of the vehicle. Vehicle silhouettes corresponding to the required view are presented the user, they then take that perspective view and the next view silhouette is presented until all the required views are photographically captured. Optionally, the silhouette may be presented as the user is aligning the photographic image on their device display; i.e. can match the vehicle outline to the silhouette outline in their viewfinder. Alternatively, the silhouette is presented and then disappears when the camera is engaged on the local device.

Once this is completed the Vehicle Condition section of the inspection may be completed. The User 110 is prompted, item by item to enter the condition of the respective item. The User 110 may be presented with a slider to score the condition from 0-5, for example. Verbal descriptions of the condition that correspond to each number on the slider are presented to facilitate consistent reporting. It would be evident that other haptic interfaces, score ranges etc. may be employed without departing from the scope of the invention.

The inspection is ideally comprehensive but may vary according to the assessment being performed and may include, but not be limited to, any or all of the following:

Exterior: Inspect frame for structural damage due to collision; collision repairs that are below industry standards; significant dents, dings, and scratches; missing or broken components including glass and mirrors; operation of exterior lighting; abnormal wear and condition of tires (includes spare); record tire size, brand and amount of tread remaining on each tire; and significant damage to wheels and/or hubcaps.

Interior: Record all accessories, verify proper operation of all factory equipment; damage or wear to seats, carpets, headliner, sun visors, trim pieces, dash and console areas; missing or broken items; and evidence of flood or water damage.

Chassis: Inspect for damage or wear to exhaust system; steering system, shock absorbers, struts and CV boots; transmission, differential or power steering leaks; and evidence of frame or structural damage due to collision.

Engine: Inspect for significant oil or coolant leaks; condition of fluids, belts and hoses for wear or need of replacement; serious mechanical problems indicated by abnormal noises; evidence of overheating, poor running condition or exhaust smoke; missing or damaged components.

Road Test (Optional): During the road test the User 110 checks for any unusual behaviour or noises from the engine, suspension, brakes, etc. Checks that the car tracks straight, accelerates smoothly, idles smoothly, turns and brakes as expected.

Vehicle Odometer etc.: Standard display information such as vehicle mileage etc. are recorded from the vehicles display.

Diagnostic Data: In some inspections and/or assessments the inspector may be a qualified mechanic and/or qualified user able to access and acquire information stored within an onboard computer or computers of the vehicle such as On-Board Diagnostic (OBD) trouble codes etc., fluid and battery levels, upcoming maintenance requirements, vehicle use data such as duration of use, travel speeds, acceleration/deceleration events, etc.

Once the User 110 has completed the inspection, the AAM-ASP software in execution upon the Device 112 validates the inputted information for internal consistency and/or compliance with rules established in dependence upon one or more factors including, but not limited to, the type of assessment, vehicle type, jurisdiction, etc. The Device 112 may, for example, warn the User 110 that certain information has not been entered or it has been entered incorrectly. Such inspection validation procedures enhance productivity, as the User 110 does not have to return to re-inspect the vehicle, and ensures more complete and accurate information which increases user's confidence in the system. Once the User 110 has reviewed the inspection summary, the inspection is Submitted. The information collected during the inspection process is then uploaded.

Within embodiments of the invention the completion of the assessment is based upon the exploitation of one or more algorithms that calculate one or more condition scores based on the information collected during the inspection process and a Vehicle Condition Report is generated. For example, condition scores for exterior, interior, mechanical, and overall may be calculated. The Inspection Report may in some assessments, such as for retailing of the vehicle inspected, be published and a Condition Badge generated. This badge contains the overall conditions score and can be embedded on websites, in online advertising, in the car window etc. pertaining to that specific vehicle inspected. Where the badge is clicked by a remote party in an online environment then the remote party may be provided with additional information which may be at various levels according to the third party and/or their subscription basis to the online application. For example, vehicle retailers and/or distributers may seek more detailed information than a private individual buying directly. Accordingly, the additional information may vary from the time/location of the last assessment through a summary of assessments made, to a full Condition Report populated with all the information acquired and determined by the inspector.

Now referring to FIGS. 6A and 6B there are depicted exemplary server and web server deployment scenarios 600 and 650 respectively for vehicle assessment applications, systems and platforms according to embodiments of the invention. As depicted in first schematic 600 a Network 200 conveys information to and from Devices 112. The Network 200 can, for example, allow Devices 112 to communicate with a Computer 614 coupled to a Database 616 via a Web Server 618. The Database 616 may store information including but not limited to Inspection Rules 616A, Damage Severity Data 616B, Application Software Updates 616C, Inspection Schedules 616D, Inspection Reports 616E, and other information. Computer 614 (which may for example comprise or include a SQL, Oracle or other database server in one exemplary illustrative non-limiting implementation) downloads data from database 616 to requesting Devices 112 and uploads information from the Devices 112 to Database 616. Computer 614 may comprise a cluster or network of computers including for example a rules-based workflow engine that handles and schedules inspection, and sends out workflow assignments to particular Users 110 based on geographic proximity, availability and other factors. The Network 200 may provide constant, periodic, occasional and/or infrequent connection between Computer 614 and Devices 112. In one exemplary illustrative non-limiting implementation, the Network 200 may comprise or include a bank of modems and/or Internet routers communicating using TCP/IP or any other desired communications protocol(s), but other wireless or wired networking capabilities may be used as desired.

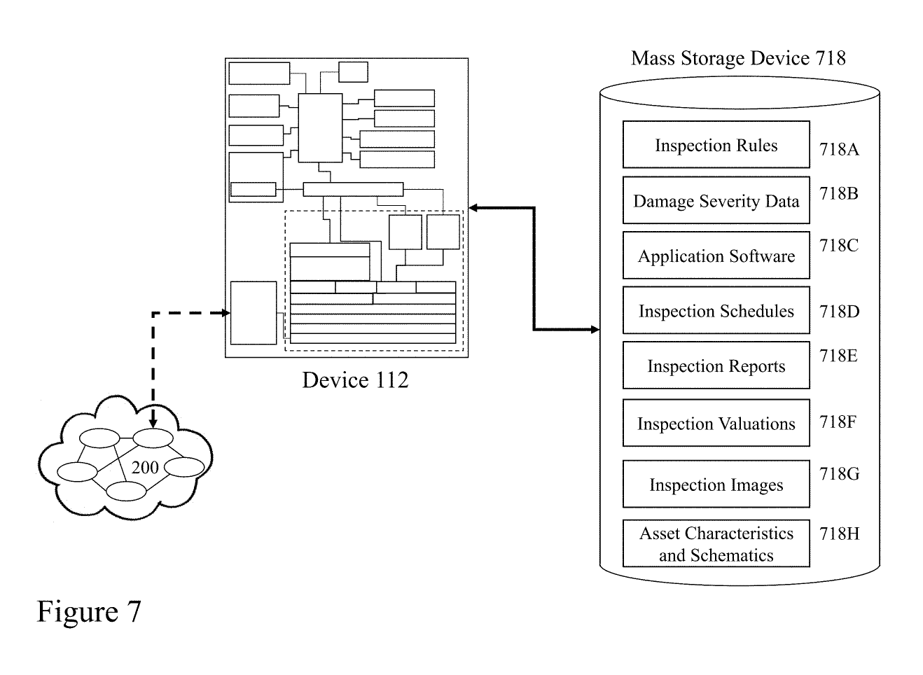

In FIG. 6B with second schematic 650 the Web Server 618 is depicted coupled to a Database 616 (or a mirrored copy of same) allowing remotely located web browser clients, Users 110, to access and display or otherwise process inspection reports and/or other information stored within the database 616 via the Network 200 on PEDs and/or FEDs whilst assessment data is pushed to the Web Server 618/Database 616 from Devices 112. In an alternate embodiment of the invention depicted in FIG. 7 assessment data is stored from a Device 112, e.g. Electronic Device 204 in FIG. 1A directly into a Mass Storage Device (MassStor) 718. The Device 112 being in some embodiments of the invention connected periodically or quasi-continuously to Network 200 whereas in other embodiments of the invention the Device 204 and MassStor 718 are not connected to an open network such as Network 200 but are connected via a secure network or are only connected to a self-contained network. In such instances the assets being assessed may be commercially and/or military sensitive such that open network access is not desirable. In such, scenarios the MassStor 718 is configured to store Inspection Rules 718A, Damage Severity Data 718B, Applications Software 78C, Inspection Schedules 718D, Inspection Reports 718E, Inspection Valuations 718F, Inspection Images 718G, and Asset Characteristics and Schematics 718H. Optionally, Device 112 is a ruggedized PED with Encrypted/Secure MassStor 718. Optionally, Device 112 is a PED with MassStor 718 internally configured as part of the Device 112 wherein the Device 112 is configured solely for inspection/assessment applications.

Within embodiments of the invention where a User 110 is acquiring images relating to an asset then as depicted supra the user may be presented with a schematic allowing them to identify the region of the asset to which an image of a defect or damage etc. relates. The schematic may be free format allowing the user to select any point on the schematic or it may be partitioned such that associations are to specific portions of the asset. For example, for a vehicle the associations may be hood, trunk, roof, rear side, front side, and doors. In this manner, when the User 110 taps, for example, a driver front door, the damage might not be to the door panel itself, but rather to the door handle, door hinge, door molding, etc. If all of those subsidiary parts were displayed in the flattened schematic image, the schematic image would become over-detailed and crowded. Accordingly, the user may be presented with a drop-down menu having selected a door to define a limited number of sub-sections of the door. Optionally, in other embodiments of the invention the AAM-ASP may provide multiple levels of sub-menu and sub-sections such that the User 110 can be very specific such as defining a damage for an insurance assessment or lease return, that can then form the basis of a cost-estimate for repair and hence an insurance assessment of repair-write-off.

The exemplary illustrative non-limiting inspection device typically has a touch screen user interface. For example, a schematic diagram of the vehicle being inspected may be displayed on the touch screen. The User 110 can use a stylus, finger or other pointing device to indicate damage location on the displayed schematic diagram. Different schematic diagrams can be displayed for different types of vehicles. For example, in the case of motor vehicles, a different schematic illustration can be displayed depending upon on whether the vehicle being inspected is compact, hatchback, sedan, sports utility vehicle, truck or other vehicle type. These may be generic schematics, e.g. one for all SUVs or these may be manufacturer/model specific. For example, an inspector for an insurance company may employ generic schematics whilst a mechanic at a car dealership may exploit specific schematics for each of the vehicle models sold by that car dealership.

Within other embodiments of the invention it would be evident that the inspection process may include the use of additional sensors and/or gauges to further automate and objectify the inspection process which may be wired or wireless. Such sensors and gauges may be more common and extensive in the road test/inspection aspects rather than within the inspection. However, for inspection such gauges may include odors, smoke, mold/mildew, etc.

Sensors and gauges may include, but not be limited to, measurement gauges such as tread depth, brake thickness, scratch length; paint depth gauges to verify prior repaint; on-board diagnostics (OBD) such as to capture error codes, usage information, etc.; window tint meter; 3D surface scanner to provide automated topographical surface defect capture for dents, creases, rust, surface irregularity, etc. As vehicle operating systems enable remote/wireless access to vehicle data such as; usage (distance travelled, geography covered, average/maximum speeds, engine overheating, collision indicative acceleration/deceleration events, etc.), mechanical (brake life, oil condition, etc.) and electrical condition (battery charge/capacity, etc.); such data will be retrieved wirelessly at vehicle switch inspections in rental, share and autonomous transport service scenarios.

Within other embodiments of the invention it would be evident that the inspection process may include the use of defect histograms or other statistical analysis for before and after condition comparison wherein differences between before/after may be automatically identified which may be more suitable for rental and shared vehicle scenarios; i.e. determining the damage liability for specific users. For example, using augmented reality, a user can “walk” the vehicle with a smartphone camera/viewfinder and see the prior defects superimposed on the vehicle, anything incremental is captured as new defects to be addressed and updated to the database. Alternatively, the user can define a location automatically by touching its location on a display associated with a camera such as a smartphone camera for example. As each such event may be time-stamped and/or user then an administrator or other approved/authorised user may retrieve and view inspection data before a specific point in time, after a specific point in time, by a specific user, etc. or may view differences only between specific dates and/or users. For example, does a trainee or inexperienced inspector miss defects/damage etc. or over compensate and register defects an experienced inspector or supervising inspector does not register.

Within other embodiments of the invention it would be evident that the inspection process may include the use of market price assessment wherein the reporting is integrated with sales data (new and used sales transactions) data bases such that the condition information determines the value placement of the asset on the “bell curve” of the current market price-condition profile.

Within other embodiments of the invention it would be evident that the inspection process may include the generation of an automated repair cost assessment. In this manner the inspection may integrate with parts and repair labor databases to automate the determination of values for insurance claim calculation etc.

Within other embodiments of the invention it would be evident that the inspection process may include the use of an automated image acquisition system such as within high frequency inspection applications as vehicle rentals etc. or where removal of user bias/variations is sought. In such situations an external multi-camera acquisition system may capture the asset wherein these images are image processed for defect identification, differences relative to a prior inspection determined, and a condition report/defect event report generated. Accordingly, a rental vehicle is inspected with increased consistency at low labour overhead as it moves from one rental location to another or is inspected nearly every day as users rent for short periods such as at airports. A similar multi-acquisition device may be employed for internal image capture wherein the operator opens a door, inserts the device, raises it to a defined stop height and triggers acquisition.

Within other embodiments of the invention it would be evident that as vehicles become more autonomous and/or shared in nature that systems may be embedded into the vehicles to capture before/after usage and condition data such as interior sensors/cameras that capture a snapshot of the interior after a use and similarly a snapshot of the mechanical/electrical condition (mileage, fuel/battery capacity, extreme driving events, etc.) that are uploaded to a local or centralized database on user sign-out/sign-in of a vehicle. The exterior condition may also include an external image/surface scan acquisition to assess the exterior condition as a vehicle drives through a gateway of a rental lot, autonomous taxi rank, etc. Such systems may also be linked to dashboard cameras etc. to capture driving behaviour etc.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. Computer executable instructions stored on a non-volatile non-transitory storage medium for execution by a microprocessor, the instructions when executed by the microprocessor relating to a process comprising the steps of:
receiving upon an electronic device comprising the microprocessor and non-volatile non-transitory storage medium a vehicle condition query from a remote electronic device comprising information relating to an assessment to be performed;
receiving identification data of a vehicle for transmittal to the remote electronic device allowing remote verification that the vehicle to which the identification data relates is the vehicle to which the vehicle condition query relates;
upon verification providing to a user of the electronic device access to a vehicle condition query completion process comprising:
retrieving from a first remote database data metrics corresponding to the vehicle associated with the vehicle condition query;
retrieving from a second remote database schematic data corresponding to the vehicle associated with the vehicle condition query, the schematic data relating to at least one of interior schematics, exterior schematics, and engineering schematics of the vehicle;
providing a graphical user interface allowing the user to identify specific areas of the vehicle;
providing to the user within the graphical user interface a means to associate text data and image data to the identified specific area of the vehicle; and
transmitting for storage in association with at least one of the vehicle condition query and verified identification data to a third remote database inspection data relating to the identified specific areas of the vehicle together with their associated text data and image data.

2. The computer executable instructions according to claim 1, the instructions when executed relating to the further steps of at least one of:
establish communications between at least one of the remote electronic device and the electronic device and a vehicle management system associated with the vehicle and retrieving vehicle stored inspection data; and
receiving from the remote electronic device report data, the report data comprising:
an overall condition of the vehicle based upon analysis of the inspection data;
a vehicle condition report including the one or more visual condition descriptors indicative of the condition of the vehicle; and
providing the user of the electronic device with the ability to present the report data to another user.

3. The computer executable instructions according to claim 1, wherein
the received verification data is at least one of text data and image data and relates to at least one of a Government issued license identifier, a license plate number, a manufacturer's name, a year of manufacture, a model name, a model number, a color, a vehicle identification number (VIN), a registered owner name, owner contact information, or an insurance policy identifier.

4. The computer executable instructions according to claim 1, wherein
providing to the user a means to associate image data to the identified specific area of the vehicle comprises allowing the user to select at least one of an acquired digital image file and an acquired digital video file.

5. The computer executable instructions according to claim 1, wherein
providing to the user a means to associate text data to the identified specific area of the vehicle comprises allowing the user to select from presented content established in dependence upon the received data metrics.

6. The computer executable instructions according to claim 2, wherein
providing the ability to present the report data to another user comprises providing the user with the ability to at least one of display the report data, electronically transmit the report data to the another user, and print the report data.

7. The computer executable instructions according to claim 1, wherein
retrieving the schematic data relating to at least one of interior schematics, exterior schematics, and engineering schematics of the vehicle comprises receiving at least one of a baseline schematic relating to the at least one of and rendered annotations relating to inspection data provided in response to a previous vehicle inspection query relating to the vehicle, the rendered annotations being protected to prevent a user action relating to the rendered annotations.

8. The computer executable instructions according to claim 1, the instructions when executed relating to the further steps of:
receiving information data from at least one of the user of the electronic device, a fourth database storing information relating to the vehicle, and a registered owner of the vehicle, the information data relating to at least one of a Governmentally defined jurisdiction relating to a vehicle registration, a registered usage of the vehicle, usage data relating to users of the vehicle, accident data relating to the vehicle, repairs performed to the vehicle, scheduled maintenance performed on the vehicle, and regulatory data relating to the vehicle.

9. A method comprising:
receiving upon an electronic device comprising the microprocessor and non-volatile non-transitory storage medium a vehicle condition query from a remote electronic device comprising information relating to an assessment to be performed;
receiving identification data of a vehicle for transmittal to the remote electronic device allowing remote verification that the vehicle to which the identification data relates is the vehicle to which the vehicle condition query relates;
upon verification providing to a user of the electronic device access to a vehicle condition query completion process comprising:
retrieving from a first remote database data metrics corresponding to the vehicle associated with the vehicle condition query;
retrieving from a second remote database schematic data corresponding to the vehicle associated with the vehicle condition query, the schematic data relating to at least one of interior schematics, exterior schematics, and engineering schematics of the vehicle;
providing a graphical user interface allowing the user to identify specific areas of the vehicle;
providing to the user within the graphical user interface a means to associate text data and image data to the identified specific area of the vehicle; and
transmitting for storage in association with at least one of the vehicle condition query and verified identification data to a third remote database inspection data relating to the identified specific areas of the vehicle together with their associated text data and image data.

10. The method according to claim 9, the instructions when executed relating to the further steps of at least one of:
establish communications between at least one of the remote electronic device and the electronic device and a vehicle management system associated with the vehicle and retrieving vehicle stored inspection data; and
receiving from the remote electronic device report data, the report data comprising:
an overall condition of the vehicle based upon analysis of the inspection data;
a vehicle condition report including the one or more visual condition descriptors indicative of the condition of the vehicle; and
providing the user of the electronic device with the ability to present the report data to another user.

11. The method according to claim 9, wherein
the received verification data is at least one of text data and image data and relates to at least one of a Government issued license identifier, a license plate number, a manufacturer's name, a year of manufacture, a model name, a model number, a color, a vehicle identification number (VIN), a registered owner name, owner contact information, or an insurance policy identifier.

12. The method according to claim 9, wherein
at least one of:
providing to the user a means to associate image data to the identified specific area of the vehicle comprises allowing the user to select at least one of an acquired digital image file and an acquired digital video file; and
providing to the user a means to associate text data to the identified specific area of the vehicle comprises allowing the user to select from presented content established in dependence upon the received data metrics.

13. The method according to claim 10, wherein
providing the ability to present the report data to another user comprises providing the user with the ability to at least one of display the report data, electronically transmit the report data to the another user, and print the report data.

14. The method according to claim 9, wherein
retrieving the schematic data relating to at least one of interior schematics, exterior schematics, and engineering schematics of the vehicle comprises receiving at least one of a baseline schematic relating to the at least one of and rendered annotations relating to inspection data provided in response to a previous vehicle inspection query relating to the vehicle, the rendered annotations being protected to prevent a user action relating to the rendered annotations.

15. The method according to claim 9, the instructions when executed relating to the further steps of:
receiving information data from at least one of the user of the electronic device, a fourth database storing information relating to the vehicle, and a registered owner of the vehicle, the information data relating to at least one of a Governmentally defined jurisdiction relating to a vehicle registration, a registered usage of the vehicle, usage data relating to users of the vehicle, accident data relating to the vehicle, repairs performed to the vehicle, scheduled maintenance performed on the vehicle, and regulatory data relating to the vehicle.

16. A method comprising:
receiving at a server a request for assessment data relating to a vehicle, the request including at least vehicle identification data of the vehicle and an electronic address of a remote electronic device to which the assessment data is to be sent
upon verification of the request transmitting to the remote electronic device an assessment report, the assessment report generated in dependence upon an aspect of the request and comprising:
a first portion retrieved from a first database relating to data metrics corresponding to the vehicle associated with the vehicle identification data;
a second portion retrieved from a second database relating to schematic data corresponding to the vehicle associated with the vehicle identification data, the schematic data relating to at least one of interior schematics, exterior schematics, and engineering schematics of the vehicle;
a third portion retrieved from a third database relating to content previously generated by a user performing an assessment of the vehicle, the content comprising at least one of audiovisual images, visual images, text data, classification data, and classification ratings; and
an assessment score determined by one or more algorithms employing a predetermined portion of the content previously generated by the user performing an assessment of the vehicle.

17. The method according to claim 16, wherein
aspect of the request is at least one of an identity of the requester, an identity of an entity to which the requester is associated, an identity of an entity to which the vehicle is associated, a subscription level of the requester, a login credential of the requester, and a type of assessment report.

18. The method according to claim 16, wherein
the assessment report comprises:
an overall condition of the vehicle based upon analysis of the previous assessment of the vehicle;
a vehicle condition report including the one or more visual condition descriptors indicative of the condition of the vehicle;
the assessment score; and
a logo associated with the provider of the previous assessment; and
the assessment report may be uploaded to at least one of an advertisement relating to the vehicle, a social network, and an online service provider or electronically transmitted to a third party.

19. The method according to claim 16, wherein
the assessment report comprises electronic content capable of being at least one of uploaded to a web based application website, uploaded to a web based service, and electronically transmitted:
an overall condition of the vehicle based upon analysis of the previous assessment of the vehicle;
a vehicle condition report including the one or more visual condition descriptors indicative of the condition of the vehicle;
the assessment score; and
a logo associated with the provider of the previous assessment; and
upon selection of at least one of the assessment report and the logo the user making the selection is provided with a second assessment report which contains all of the content previously generated by a user performing an assessment of the vehicle together with a fourth portion of the first database and a fifth portion of the second database.

20. The method according to claim 16, wherein
the received vehicle identification data is at least one of text data and image data and relates to at least one of a Government issued license identifier, a license plate number, a manufacturer's name, a year of manufacture, a model name, a model number, a color, a vehicle identification number (VIN), a registered owner name, owner contact information, or an insurance policy identifier.
